(19) United States
(12) Patent Application Publication
(10) Pub. No.: US 2020/0192477 A1
(43) Pub. Date: Jun. 18, 2020

(54) MODULAR HAND-MOUNTED INPUT DEVICE

(71) Applicant: Paul Fuqua, Littleton, CO (US)

(72) Inventor: Paul Fuqua, Littleton, CO (US)

(21) Appl. No.: 16/624,289

(22) PCT Filed: Jun. 18, 2018
(86) PCT No.: PCT/US2018/038088

§ 371 Date: Dec. 18, 2019

(51) Int. Cl. G06F 3/01; G06F 3/041; G06F 3/0488; G06F 3/0346

(52) U.S. Cl. CPC G06F 3/014; G06F 3/041; G06F 2203/04808; G06F 3/016; G06F 3/0346; G06F 3/04883

(57) ABSTRACT

A modular input device that may be supportably engaged by the hands of the user such that independent hand-specific modules are provided. The modules may include a touchscreen input device that may be utilized to provide inputs to a computing device. The configuration of the modules may include a palm engagement portion and the control surface extending therefrom. The palm engagement surface may coordinate with the fastener to conformingly engage the palm of the user at a proximal portion thereof such that the metacarpophalangeal joints of the user's fingers may retain a full range of motion, thus facilitating improved typing using the touchscreen input device. The hand-specific modules may be configurable and/or adjustable in a number of ways to facilitate different users with varying hand sizes while engaged in varying computing activities.

### RELATED APPLICATIONS

This application claims the benefit of U.S. Provisional Patent Application No. 62/523,925 filed Jun. 23, 2017, entitled “MODULAR HAND-MOUNTED INPUT DEVICE,” which is incorporated herein by reference in its entirety.

### BACKGROUND

A variety of input devices have been contemplated for use in connection with computing devices to facilitate human-machine interaction therebetween. Possibly most common among these is the standard “QWERTY” keyboard that comprises a plurality of keys arranged in rows that correspond to various characters and function inputs for use in interaction with a computing device. Various other common input devices include mouse devices, and more recently touchscreen interfaces, that facilitate human-machine interaction.

Traditional input devices have typically not been designed with a focus on ergonomics such that the layouts and physical configurations of the input devices have been largely driven by function. As the computing paradigm has evolved to include the use of mobile smart phone and tablet devices, the corresponding use of input devices has also evolved. However, the prevalence of keyboards (both physical and virtual), mice, and touchscreens continues to dominate the majority of applications for human-machine interface. While advances have been made with respect to keyboard layouts that arrange physical keys in a more ergonomic fashion, such keyboards are often still required to be supported on a surface such as a desktop or the like. In turn, the traditional keyboard continues to be focused on applications in which a keyboard and monitor combination is used to facilitate the user interface that is manipulated by way of inputs to the input device resting on the desktop.

In the context of mobile devices, the prevalent input mechanism has evolved to include a simulated or virtual keyboard on the screen of a device such that the keyboard is manipulated by way of touch inputs to a touch sensitive display. Such on-screen input devices allow for flexibility in relation to the keys that may be presented to a user, however the layout typically mimics that of a standard keyboard.

As the computing paradigm continues to evolve with the incorporation of new technologies including, for example, virtual reality and augmented reality computing systems, the configuration and utilization of input devices must also continue to evolve. That is, traditional input devices may not be suitable for applications in modern or future computing environments such that the need for continued improvement thereof exists.

### SUMMARY

In view the foregoing, the present application relates to a unique human-machine interface device. Specifically, the device may include corresponding, hand-specific units adapted for engagement with the left and right hands, respectively, of a user. The units may be attachably engageable with the hands of a user such that the units are maintained in position relative to the user's hands without user having to grip or otherwise retain the units by way of the user's fingers or thumb. The units may be engageable with the user's hand such that portion of the user's palm, notably the area surrounding the metacarpophalangeal joints, are unobstructed to provide a full range of motion of the user's fingers and/or thumb for utilization and selection of inputs provided on the units. The units may further include a touchscreen input device that may be engaged with the fingers of the user and/or additional user input devices that may be engageable by the user's thumb. Moreover, the units may be particularly adapted for use by different users having variable hand sizes by way of configurations of both physical and virtual components of the units.

In turn, the human-machine interface device described herein may be useful in a number of contexts. Specifically, as computing paradigms continue to shift from desktop computing to mobile computing to virtual and augmented reality environments, the interface device described herein may be useful in any such contexts. Specifically, the input device may be utilized in traditional sense with a standard desktop or laptop computer. Further still, the device may be configured for communication with a mobile device. As may be appreciated, given the flexibility in environments in which mobile devices may be utilized, use of the interface device described herein may facilitate nontraditional settings such as when a user is in a seated position, standing position, or even lying or prone position.

Further still, the human-user interface device may be suited for use in augmented and virtual reality contexts. Specifically, such contexts often require a user's hands to be free for movement throughout a space for interaction with the augmented or virtual reality environment. However, user may still be required to provide a traditional style inputs to a computing device in the context of the virtual or augmented environment. In this regard, the use of the hand-specific units mounted to a user's hands may provide the flexibility for movement of the user's hands through the environment while still allowing for readily providing inputs to the device. As the human-user interface device is contemplated for use with augmented reality or virtual reality contexts and the human-user interface is designed to be engaged with the user's hands, the human-user interface device may engage or include markers for use in monitoring the position of the human-user interface device and, in turn, the user's hands. As may be appreciated, use of markers for motion capture in relation to virtual or augmented reality applications is common. As such, provision of a marker with the human-user interface device may allow for a user to interact with the human-user interface device while allowing for tracking of the user's hands. The markers may be any appropriate active or passive marker including, for example, IR emitters, IR reflectors, LED emitters, visible light reflectors, or the like.

Further still, the input device may be used with computer-operated devices or may be used to otherwise control devices (e.g., remote-controlled vehicles, robotics, etc.). These devices may generally include a computing device that is operative to receive and interpret the inputs from the input device. Moreover, the input device may be in operative communication with a plurality of devices to provide inputs to the plurality of devices. In this regard, the device may be used in a variety of contexts and provide advantages in each including improved ergonomics, flexibility of location, configurability, and other beneficial attributes not typically present in traditional input devices.

Accordingly, an aspect includes an input device for human interaction with a machine such as a computing device. The input device includes a first hand-specific unit and a second hand-specific unit for respective corresponding use with the right and left hands of a user. Each of the hand-specific units include a palm engagement portion comprising an ergonomically contoured surface adapted for conforming engagement with a palm of a user. The units also each include a fastener engaged with the input device and extending relative to the palm engagement portion for disposing the fastener about a hand of a user to maintain contact between the palm of the user and the palm engagement portion when the fastener is disposed about the hand of the user. The thumb and each finger of the user remain free to move relative to the user input device when the fastener extends about the hand of the user. Each unit also includes a control surface extending relative to the palm engagement portion that includes a touchscreen input device alignable with the fingers of the user when the hand of the user is engaged with the fastener. In turn, the user is operative to contact the touchscreen input device with corresponding distal tip portions of each finger of the user to provide an input to the computing device.

A number of feature refinements and additional features are applicable to the foregoing aspect. These feature refinements and additional features may be used individually or in any combination. As such, each of the following features that will be discussed may be, but are not required to be, used with any other feature or combination of features of the foregoing aspect.

For instance, the input device may further include a wireless communications device for wireless communication of the input to the computing device. Any appropriate wireless communication device may be provided. Moreover, a first of the hand-specific units may include a first short-range communication device for communication with the other of the hand-specific units. In turn, the other hand-specific unit may include a longer-range communication device for communication of input signals from both units to a computing device. In addition, the input device may facilitate both upstream and downstream communications. That is, input device may provide upstream communication to a computing device for provision of inputs to the computing device. In addition, the input device may provide downstream communications to another device to control the another device. Further still, the input device may relay communications from an upstream device (e.g., a computing device) to a downstream device (e.g., a device to be controlled). In turn, the input device may effectively extend the range at which a computing device may communicate with the device to be controlled. Furthermore, the input device may augment or modify commands provided to the device to be controlled.

In an embodiment, the palm engagement portion may extend relative to the palm of the user proximally to the metacarpophalangeal joint of each of the fingers of the user. The fastener may include a first strap extending about the hand of the user from between the metacarpophalangeal joint of the index finger of the user and the metacarpophalangeal joint of the thumb of the user and a lateral edge of the hand opposite the thumb proximal to the metacarpophalangeal joint of the adjacent finger. The fastener may also include a second strap extending about the hand of the user from proximal to the metacarpophalangeal joint of the thumb to the lateral edge of the hand opposite the thumb proximal to the metacarpophalangeal joint of the adjacent finger.

In an embodiment, the touchscreen device of the control surface may include resizable input portions for selection by the user. The resizable input portions may be calibrated to a user's finger based at least in part on the size of the user's fingers. Additionally or alternatively, a layout of the input portions may be configurable by a user. In addition, the layout of the input portions may be configurable relative to an application or task for which the input device is utilized.

In an embodiment, at least one of the hand-specific units may include an input device disposed adjacent to the user's thumb for manipulation of the input device by the user's thumb. This input device may include a touch screen device, joy stick, button, slider, or any other appropriate input positioned for manipulation by a user's thumb.

The touchscreen device may be operative to receive a multi-finger gesture to control a layout of input portions provided on the touchscreen device. For instance, a plurality of screens of input portions may be provided that are navigated by way of the multi-finger gesture.

In relation to physical adjustability of the units, the control surface is adjustably positionable relative to the palm engagement portion. For instance, the control surface may be hingedly engageable with the palm engagement portion to facilitate pivotal movement of the control surface relative to an axis generally extending parallel to an axis defined by the metacarpophalangeal joints of the fingers of a user.

In certain contexts, it may be useful to use the hand-specific units as a single, integrated unit. As such, the respective hand-specific units may be engageable for attachment while engaged with the hands of a user. In this configuration or in other configurations, at least one of the hand-specific units may be adapted to supportively engage a user device. For instance, each of the hand-specific units may be adapted to collectively supportively engage the user device (e.g., such that the user device is supported between the respective hand-specific units).

In certain embodiments, each of the hand-specific units may include a haptic feedback actuator for providing tactile feedback in response to a user contacting an input portion of the touchscreen device. Further still, each of the hand-specific units may include a motion sensor for determination of movement of the respective hand-specific unit. As described above, the units may also include markers for use in tracking the units in a given field (e.g., for use with augmented or virtual reality). In this regard, the motion sensor may work in coordination with the marker to determine the hand position and/or orientation in the given field.

Also, either or both of the hand-specific units may be engaged with external modules. Such external modules may expand the functionality of the hand-specific units. Additionally or alternatively, such external models may provide physical or aesthetic changes to the hand-specific units. In any regard, external modules may be engageable with one or both hand-specific units. In this regard, the hand-specific units may comprise engagement features that are operative to engage one or more external modules. Furthermore, the hand-specific units may comprise communication ports or the like to facilitate operative communication with an external module.

Such external modules may facilitate a number of additional functionalities when appropriately engaged with one or more hand-specific units. For instance, the external modules may comprise additional means for receiving an input for manipulation of a computing device or other machine with which the hand-specific unit is in communication. For instance, an optical mouse module may be engageable with a hand-specific unit to facilitate use of the hand-specific unit as a mouse input for a device. In other contexts, the external module may facilitate additional communication that, for instance, may include protocols or modalities different than those used to communicate with a device for providing inputs to the device. In this regard, an external module may provide for communication to one or more devices. For instance, an external module may provide communication between the hand-specific unit and a remote device such as a robotic device, autonomous vehicle (e.g., drone), or other appropriate device to control the remote device. In addition, the hand-specific unit may also communicate with a remote computing device. Accordingly, as described above the hand-specific unit may act as an intermediary to allow for data to flow both to the remote device to be controlled and the remote computing device, which may assist in control of the remote device, receive data from the remote device, or communicate in some other way with the remote device. Other external modules may also be used without limitation that may include, for example, machine readers such as barcode scanners, RFID scanners, or the like.

Furthermore, the hand-specific unit may be programmable or otherwise configurable for coordination with an external module. For instance, by engaging an external module and establishing communication therewith, the hand-specific unit may be configurable such that a user interface presented on the touchscreen input device is specific to the external module. This may allow for specific user interfaces that relate to the use of the external module to be provided to configure the user inputs of the hand-specific unit (e.g., including both physical and software interfaces).

In further relation to the behavior of the user interfaces of the hand-specific unit (e.g., including physical and software based interfaces), as recognized above, it may be advantageous to allow for the ability to modify or customize such interfaces. In this regard, the hand-specific units may be configurable to allow for customization of the user interfaces thereof for specific contexts. Such specific contexts may be related to a device to which the hand-specific unit is connected. For instance, specific user interface configurations may be provided to control a given device to which the hand-specific unit is connected. Further still, if the hand-specific unit is used to control a computing device, the user interfaces of the hand-specific unit may be customized or modified in corresponding relation to a software program being utilized on the computing device. For instance, if running a game on the computing device, the user interfaces of the hand-specific unit may be configured in particular relation to the game.

As may be appreciated, the ability to produce customized interfaces for the hand-specific unit may be beneficially provided to third parties for development. For instance, the development kit may provide access or instructions to control interfaces such as APIs of the like that allow third parties to develop software for use with the hand-specific unit. In this regard, a development kit that includes tools that may be used to develop custom configurations of the hand-specific unit may be provided to developers. Such a development kit may allow third party developers to generate custom user interfaces for the hand-specific units. In turn, such custom user interfaces may be incorporated into software and/or hardware with which the hand-specific unit is used. For instance, such custom user interface configuration may be provided in connection with an external module or may be provided through a marketplace that allows users to access and utilize such custom user interfaces.

### BRIEF DESCRIPTION OF THE FIGURES

FIG. 1 is a perspective view of an embodiment of a hand-specific module of an input device.

FIGS. 2-5 show various different perspective views of an embodiment of a hand-specific module of an input device as engaged with a hand of a user.

FIG. 6 depicts an embodiment of a screen of input portions that may be displayed on a touchscreen input device.

FIGS. 7-9 show various different perspective views of an embodiment of a hand-specific module of an input device as engaged with a hand of a user.

FIG. 10 depicts an embodiment of hand-specific modules comprising engagement features and a communication port for operative engagement with an external module.

### DETAILED DESCRIPTION

While the invention is susceptible to various modifications and alternative forms, specific embodiments thereof have been shown by way of example in the drawings and are herein described in detail. It should be understood, however, that it is not intended to limit the invention to the particular form disclosed, but rather, the invention is to cover all modifications, equivalents, and alternatives falling within the scope of the invention as defined by the claims.

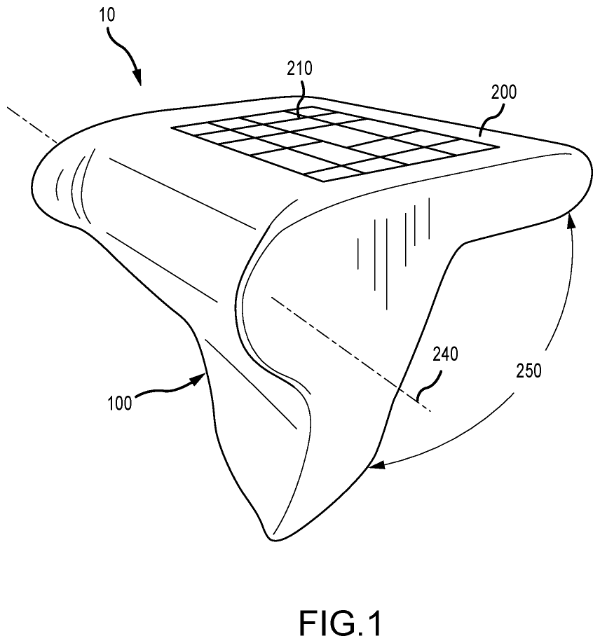

FIG. 1 depicts an embodiment of a portion of an input device. The input device may include a hand-specific unit 10 adapted for engagement with a hand of a user. For instance, the hand-specific unit 10 shown in the figures may be adapted for the engagement of the right hand of the user. In this regard, while a single hand-specific unit 10 is shown, it may be appreciated that an input device may include a first hand-specific unit and a second hand-specific unit for use with the left and right hands of a user, respectively.

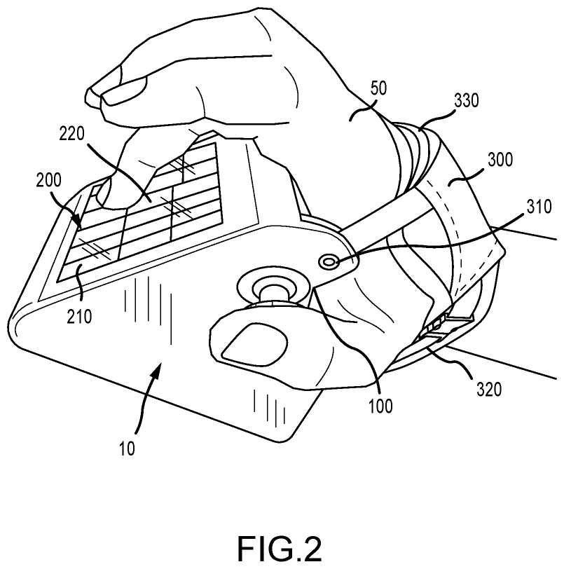

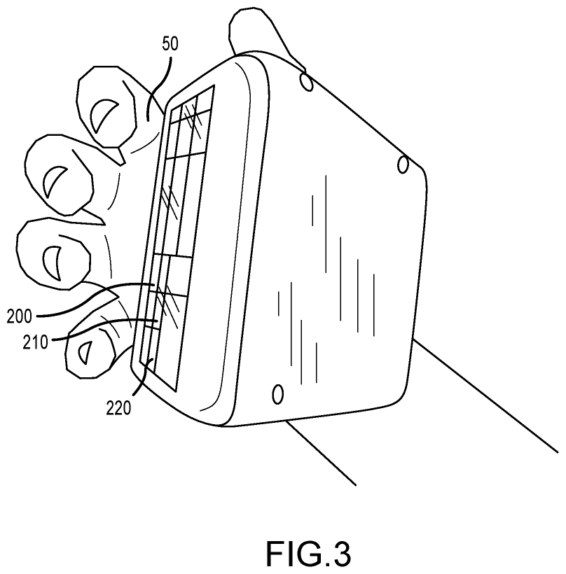

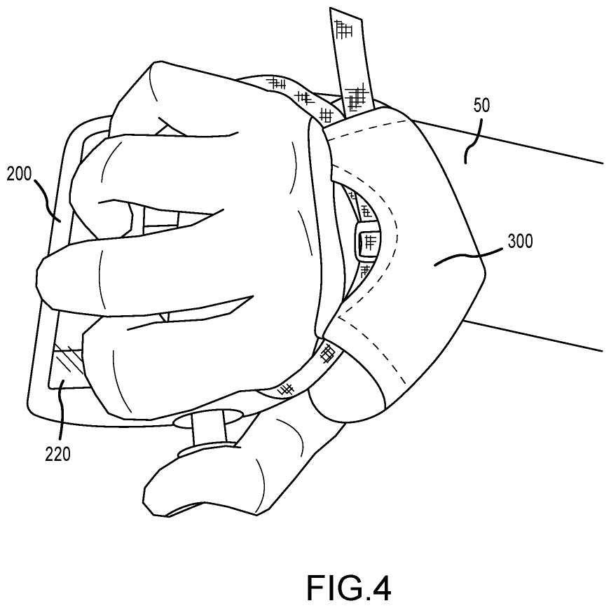

The hand-specific unit 10 may include a palm engagement portion 100 and a control surface 200 that extends relative to the palm engagement portion 100. With further reference to FIG. 2, it may be appreciated that a hand 50 of a user may be disposed such that the palm of the user's hand 50 engages the palm engagement portion 100 of the hand specific unit 10. The palm engagement portion 100 may comprise an ergonomic, contoured surface adapted for conformal engagement with at least a portion of the palm of a user as will be described in greater detail below. As may also be seen in FIG. 2, the hand-specific unit may include a fastener 300 that is adapted for engagement with the hand 50 of a user to maintain the hand 50 in conformal engagement with the palm engagement portion 100 of the hand-specific unit 10. As described above in relation to the utilization of first and seconds hand-specific units with the hand of a user, a corresponding opposite-handed version of the depicted hand-specific unit 10 may also be provided with corresponding features thereon. In an embodiment, the respective ones of the pair of hand-specific units may be mirror images of one another.

The control surface 200 that extends relative to the palm engagement portion 100 may include a touch screen input device 210. The touchscreen input device 210 may be provided on the control surface 200 such that the fingers of the user may be capable of contacting the touch screen input device 210 when the hand 50 of the user is engaged by the fastener 300 and is in engagement with the palm engagement portion 100. Accordingly, the touchscreen input device 210 may have presented thereon various input portions 220. Upon contacting the input portions 220 with the fingers of the user, the input device may be operative to generate a signal that may be communicated to a computing device corresponding to a respective character or function represented by the input portion 220 selected.

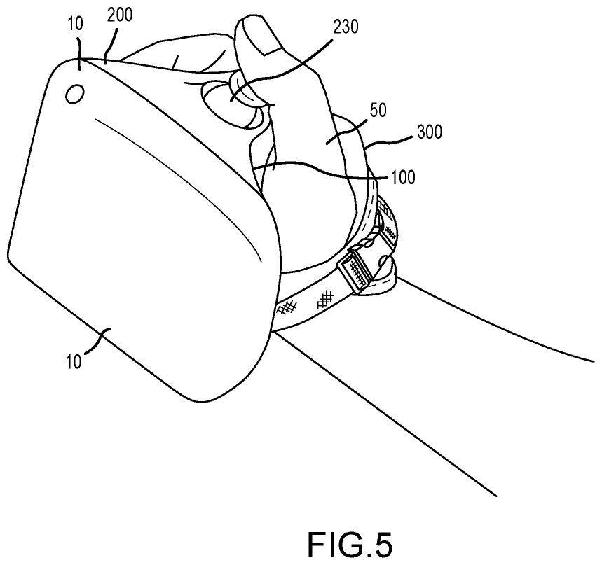

In addition, as can best be seen in FIG. 5, the hand-specific unit 10 may include one or more alternative input devices 230 that may be arranged between the palm engagement portion 100 and the control surface 200. For instance, in the depicted embodiment, the alternative input 230 may include a joystick that is positioned for manipulation by the thumb of the user when the user's hand 50 is engaged between the fastener 300 and the palm engagement portion 100 of the hand-specific unit 10. Other additional or alternative inputs 230 may be provided without limitation including, for example, sliders, physical buttons, additional touchscreen functionality, toggle switches, or the like.

In this regard, the input device may include a wireless communication module that may be utilized to communicate with one or more machines (e.g., including computing devices, robotic devices, unmanned vehicles, or other appropriate devices). Nonlimiting examples of such wireless communication modules may include a Bluetooth module, a wireless USB module, an IEEE 802.11 (Wi-Fi) module, or other appropriate communications module that is operative to wirelessly communicating signals from the input device to the computing device. In any regard, the wireless communication module may be operative to communicate a signal corresponding to an input in response to a user manipulating the alternative input 230 and/or activating an input portion 220 of the touchscreen input device 210. As will be described in greater detail below, additional communication modalities or extended communication range may be facilitated by way of an external module engaged with the unit 10. Additionally, the input device may comprise more than one communication module or utilize more than one communication modality. This may allow the input device to communicate with a plurality of devices (e.g., using different communication modalities) simultaneously.

One particular advantage to utilization of a touchscreen input device 210 may be the capability of easily adapting or changing the layout and/or function of the touchscreen input device 210. This may include easily allowing for calibrating the size and/or position of the input portions 220 presented on the touch screen input device 210. Such calibration may facilitate utilization of the input device by users having different hand sizes. For instance, a calibration mode may be initiated. In the calibration mode, various points of contact may be displayed on the touchscreen input device 210. A user may select various different ones of the presented points of contact to provide information regarding the extent of reach and/or size information regarding the user's fingers. In turn, using the calibration information, the size and/or layout of the input portions 220 may be varied.

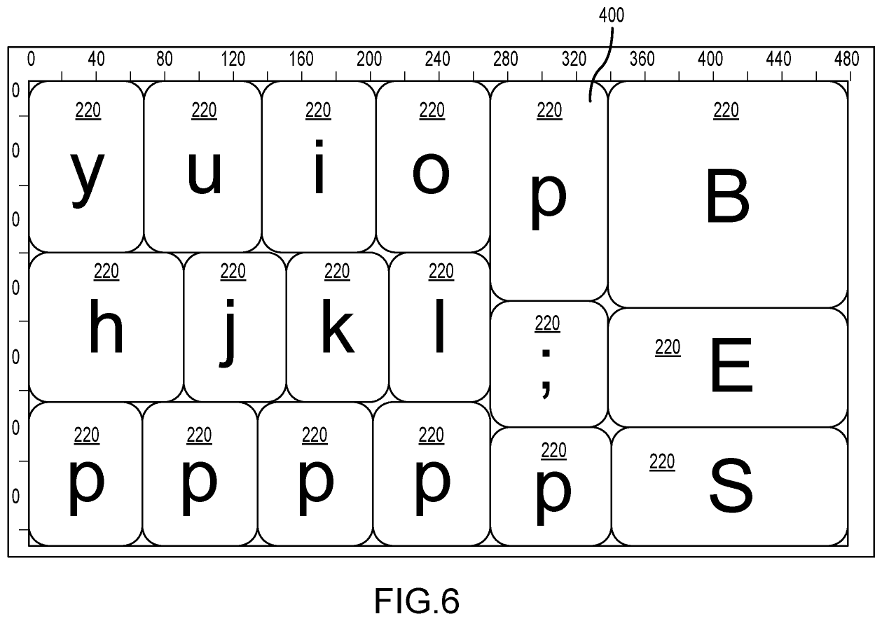

The touchscreen input device 210 may facilitate presentation of all standard keys on a keyboard and/or additional input portions beyond those commonly available on a standard keyboard to a user utilizing input device. Furthermore, the input portions 220 presented to a user may be customizable for various different keyboard layouts. This may include presentation of different input configurations that are specific to a given language and or computing application. As described in greater detail below, this may include input configurations provided by third parties using a development tool kit. Furthermore, the input portions 220 may be selectively configurable by a user, for example, even during use of the input device. For example, various different swiping gestures or other appropriate gestures may be utilized to navigate between “screens” of input portions. One such screen 400 is shown in FIG. 6 having a plurality of input portions 220 thereon. A plurality of different screens of various input portions 220 may be provided such that the user may select for display and interaction with a given one of the screens by modifying the screen displayed using a gesture input (e.g., a multi-finger gesture input such as a swipe). The input portions 220 provided on the various screens may correspond to standard keyboard layouts or, as described above, specific input portions 220 adapted for specific computing applications of the like. In this regard, at least a portion of the input portions 220 may correspond to ASCII characters. Other input portions 220 may correspond to function keys. Further still, at least some of the input portions 220 may correspond to application and/or device specific buttons. Further still, the input portions 220 and/or screens used to present the input portions 220 may be customizable or configurable by a user either using the input device by way of a counterpart computing program (e.g., an application or web-based interface) that allows for configuration thereof.

Furthermore, the touchscreen input device 210 and/or alternative input devices 230 may be modified or configured for use in a particular context. For instance, the touchscreen input device 210 and/or input devices 230 may be specifically configured for use with a given software package executing on the computing device with which the unit 10 is in communication. Alternatively, in the event the unit 10 is controlling a remote device such as a robotic device, unmanned vehicle (e.g., drone), or the like, the touchscreen input device 210 and/or alterative input devices 230 may be specifically configured for such use. Further still, as described in greater detail below, an external module may be provided in operative engagement with the unit 10. Accordingly, the touchscreen input device 210 and/or alterative input devices 230 may be specifically configured for use with the external module.

Additionally, it may be appreciated that it may be beneficial to allow third party developers to develop interfaces for the unit 10. As such, a development kit may be published that allows developers to generate software to be executed on the unit 10 to specifically configure the unit. Such software may in turn be sold in a marketplace or the like. Additionally or alternatively, such software may be provided in proprietary relation to a software package executed on the computing device with which the unit 10 is in communication, an external module provided for the unit 10, a remote device to be controlled by the unit 10, or any other appropriate hardware or software.

Furthermore, additional input signals may be generated using motion sensors disposed within each hand-specific unit 10. As may be appreciated, utilization of the fastener 300 to engage the user's hand 50 to the hand-specific unit 10 may allow the user's hand 50 to experience a full range of motion as a user would normally move the user's hands through space. In turn, a motion sensor (not shown) may be provided in the hand-specific unit 10 that may detect and interpret the movements of the hands of the user for utilization as inputs to a computing device. For instance, if working with a three-dimensional model on the computing device, movement of a given one of the hand-specific units through space may be interpreted and utilized to control corresponding movement of the three-dimensional model in the display corresponding to the computing device. As may be appreciated, such signals generated by use of motion sensor may be utilized in any number of different contexts as inputs to the computing device (e.g., including motion-based gestures). In addition, markers (not shown in the figures) may be provided on the unit 10 to assist in tracking movement of the unit 10 in a field. Such activity is common in the field of augmented or virtual reality. As such, the markers may be any appropriate active or passive marker and may include emitters such as IR or LED emitters.

Furthermore, either or both of the hand-specific units 10 may include haptic feedback actuators or the like that may provide tactile feedback to the user. For instance, the feedback actuator may include a vibrator or the like that may be utilized to simulate the tactile response of a physical key when selecting an input portion 220 on the touch screen input device 210. Other types of haptic feedback actuators and/or effects may also be utilized without limitation.

While not shown in the figures, further customizable configuration of the hand-specific unit 10 may include the capability of moving the control surface 200 relative to the palm engagement portion 100. For example, with returned reference to FIG. 1, a hinge mechanism (not shown) may be provided that allows for movement of the control surface 200 relative to the palm engagement portion 100 about an axis 240 generally extending between the palm engagement portion 100 and the control surface 200. In this regard, the included angle 250 defined between the palm engagement portion 100 and the control surface 200 may be varied by movement of the portions about the axis 240. In this regard, the movement of the control surface 200 relative to the palm engagement portion 100 may allow for positioning of the touchscreen input device 210 relative to the fingers of a user when the user's hand 50 is engaged with the unit 10. In addition, the hinged movement may allow for folding of the input device (e.g., for storage or the like).

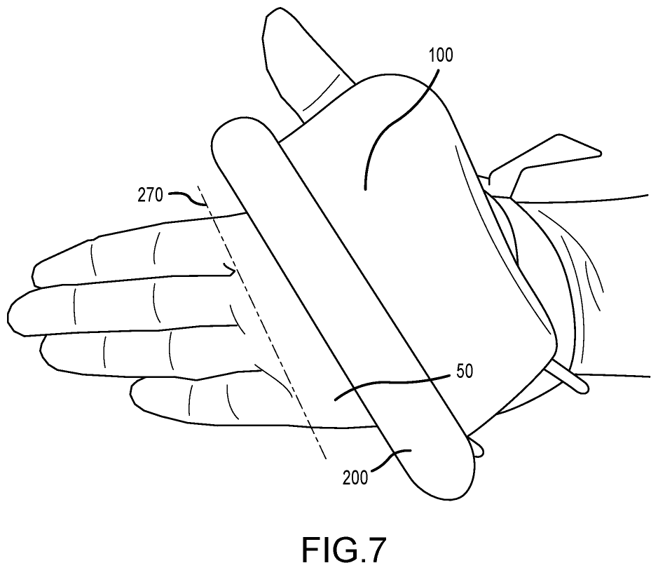

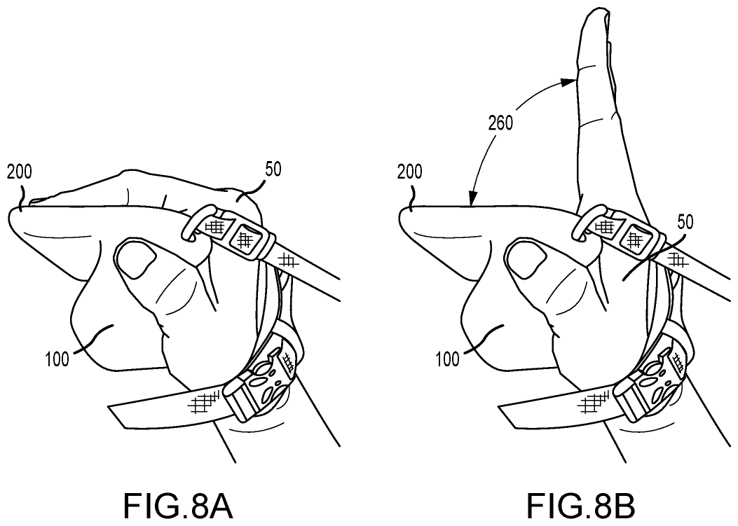

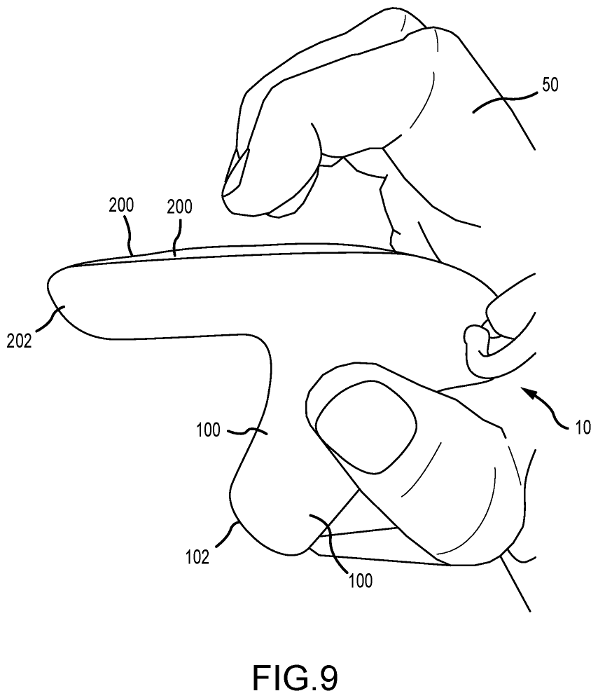

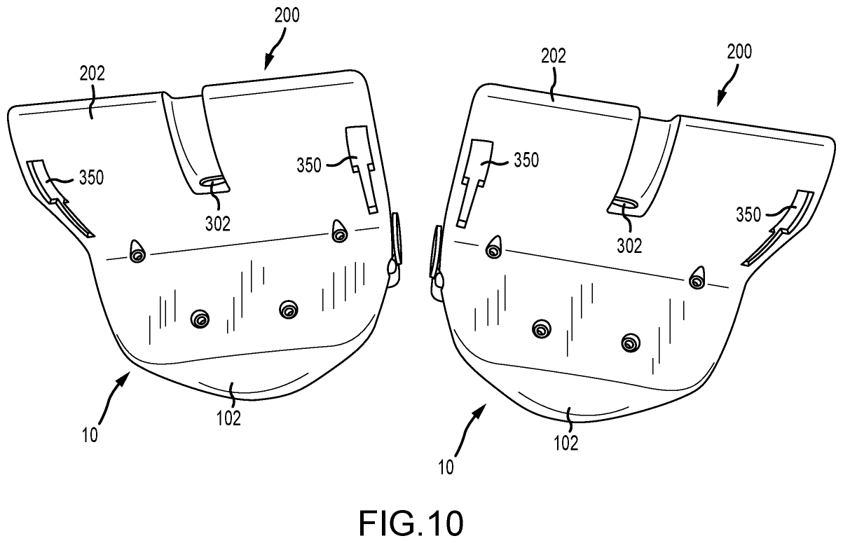

In addition, it may be appreciated that the palm engagement portion 100 may be ergonomically contoured or otherwise configured for conformal engagement with at least a portion of the palm of the user. For example, with further reference to FIG. 7, the palm engagement portion 100 may contactingly engage a portion of the palm of the user proximal to an axis 270 that generally extends along the metacarpophalangeal joints of each respective finger of the user. Accordingly, as can be seen in FIG. 7, a portion of the user's hand adjacent to the axis 270 may be exposed such that the metacarpophalangeal joints of the fingers are exposed such that the user has full range of motion of the fingers. For instance, with further reference to FIGS. 8A and 8B, the user's fingers may have a full range of motion such that the user's fingers may move from a folded position shown in FIG. 8A to an extended position shown in FIG. 8B. As may be appreciated, the total range of motion may be an angle 260 of at least about 90° of movement. As shown in FIG. 9, the positioning of the palm engagement portion 210 relative to the user's palm may allow the fingers of a user to be positioned relative to the control surface 200 for engagement with the touch screen input device 210 provided thereon such that the user has a full range of motion of the fingers to allow for selection of a plurality of input portions 220. However, with returned reference to FIG. 6, it may be appreciated that the lateral dexterity of a user's finger may be less than that associated with extension and retraction of the user's finger. As such, the configuration of input portions 220 may generally be collimated to reduce lateral movements of the fingers and improve dexterity.

In addition, the fastener 300 may be specifically provided to facilitate conformal engagement of the palm of the user with the palm engagement portion 100. For instance, with reference to FIG. 2, the fastener 300 may include a first strap 310 and a second strap 320. Both the first strap 310 and the second strap 320 may attach to the hand-specific unit 10 at a first position 330 that is adjacent to the fifth digit (i.e., pinky finger) of the user. The first strap 310 may in turn extend about the backside of the user's hand 50 and attach to the hand-specific unit 10 at a position between the metacarpophalangeal joint of the second digit (i.e., index finger) and the metacarpophalangeal joint of the thumb. The second strap 320 may extend about the backside of the user's hand 50 and attach on the hand-specific unit 10 at a position proximal to the metacarpophalangeal joint of the thumb. In this regard, the first strap 310 and second strap 320 may be attached on opposite sides of the user's thumb. This may assist in maintaining the palm engagement portion 100 in conformal engagement with the proximal portion of the user's palm such that both the user's fingers and the user's thumb are free to engage input devices on the hand-specific unit 100 without having to exert a force to maintain engagement with the device.

In alternative embodiments, the hand-specific units 10 may be adapted for resting on a surface such as a desktop or the like such that the user may still engage the hand-specific units 10 for interface with the touch screen input device 210 thereon. For example, with further reference to FIG. 9, a distal portion 102 of the palm engagement portion 100 and a distal portion 202 of the control surface 200 may be configured such that they may supportably engage the hand-specific unit 10 on a surface. This may still maintain the palm engagement portion 10 and control surface 200 in a position for engagement with the user's hand 50.

In connection with the ability for a hand-specific unit 10 to be engaged on a surface, in an embodiment a hand-specific unit 10 may include or be engaged with a module that provides functionality associated with a traditional mouse interface. That is, the hand-specific unit 10 may include an optical sensor or the like that may be used for tracking movement of the hand-specific unit 10 relative to a surface to provide mouse inputs to a connected device. Alternatively, the hand-specific unit 10 may engage with a module comprising the optical sensor or to facilitate use of the hand-specific unit 10 as a mouse when engaged with the module.

In still other embodiments, the respective hand-specific units 10 for the left and right hand, respectively may be configured so that they may be joined to form a single unit that is engaged with both hands of the user. Further still, the respective right and left units of the hand-specific units may include features that engage a device with which the units are in operative communication. For instance, the respective left and right units may have physical structure or other connectors that may facilitate engagement with a computing device such as a laptop computer, tablet computer, or smart phone device to supportably engage the device with which the left and right units are in operative communication.

As may be further appreciated, the input device, namely either the left and/or right hand-specific units, may include a power source to provide power for the operation of each respective unit. In this regard, the units may be rechargeable such that they may be placed within a docking station that allows for contacting engagement with a power supply to recharge the onboard power supply of the respective units. Alternatively, the units may utilize batteries that may be replaceable. Further still, devices such as solar panels may be provided in order to supply the requisite power to charge the power supply on each respective unit.

The foregoing provides an ergonomic input device that may be specifically adapted for engagement with the respective hands of a user. Such a device may be utilized in traditional computing paradigms to provide for input to a desktop or laptop computer. Further still, the foregoing may be particularly useful in the context of use in connection with mobile devices such as tablets or smart phone computing devices. Oftentimes such mobile devices are used outside of the context of a desk or work surface such that a desktop or surface may not be readily available for utilization in supporting a user input device. In turn, by securely engaging the input device directly to the hands of the user, the input devices may be utilized by a user to provide input even in scenarios where a desktop is not available. Such examples may be utilization of the input device while seated, in a prone or lying position, or when standing.

Further still, as the computing paradigm continues to shift and virtual and augmented reality headsets and other viewing devices become more commonplace, the present input devices may be particularly useful for providing input in relation such computing devices and/or controlling certain aspects of the virtual reality or augmented reality experience. For instance, given that each and the individual units may include motion sensors, in addition to providing the ability to provide input in the form of joystick inputs and/or keyboard inputs, the motion sensors of the input device may allow for modeling and or tracking of the user's hand movements for replication in the virtual or augmented reality space. Accordingly, the foregoing provides an input device with a number of advantages for both traditional computing paradigms and for newly emerging contexts.

As described above, an external module (not shown) may also be engaged with one or more of the unit 10 to expand the functionality and/or alter the appearance of the units 10. Specifically, the unit 10 may be provided with engagement features 350 that may physically engage an external module. The engagement features 350 may comprise slots, latches, channels, fasteners, or any other appropriate means of physically securing an external module to the unit 10. In this regard, the unit 10 may supportably engage the external module engaged with the unit 10.

In addition, each unit 10 may include a communication port 352. The external module may engage the communication port 352 to facilitate operative communication between the unit 10 and the external module. In at least some embodiments, the communication port 352 may be engaged by a connector of the external module when the external module is physically engaged by the engagement features 350. The communication port 352 may include any appropriate standard or proprietary port and connector including, for example, USB, USB-C, micro USB, a serial port, DisplayPort, or the like. Alternatively, wireless communication such as those described above may facilitate communication between a unit 10 and an external module physically engaged with the unit 10.

As described above, such external modules may be provided for a number of reasons that may include providing additional functionality to the unit 10. For instance, the external module may facilitate further input capability such as in the case of an optical mouse attachment. Other such input devices including touch pads, trackballs, or the like may also be provided as an external module. Furthermore, the external module may provide additional inputs by way of scanners or readers, such as bar code scanners, RFID readers, NFC readers, or the like. Still other functionality may also be provided through use of the external modules such as cameras, microphones, speakers, additional haptic feedback actuators, or any other appropriate sensor, actuator, or the like.

While the invention has been illustrated and described in detail in the drawings and foregoing description, such illustration and description is to be considered as exemplary and not restrictive in character. For example, certain embodiments described hereinabove may be combinable with other described embodiments and/or arranged in other ways (e.g., process elements may be performed in other sequences). Accordingly, it should be understood that only the preferred embodiment and variants thereof have been shown and described and that all changes and modifications that come within the spirit of the invention are desired to be protected.

What is claimed is:

1. An input device for human interaction with a computing device, comprising:
a first hand-specific unit and a second hand-specific unit for respective corresponding use with the right and left hands of a user, wherein each of the hand-specific units comprises:
a palm engagement portion comprising an ergonomically contoured surface adapted for conforming engagement with a palm of a user;
a fastener engaged with the input device and extending relative to the palm engagement portion for disposing the fastener about a hand of a user to maintain contact between the palm of the user and the palm engagement portion when the fastener is disposed about the hand of the user, wherein the thumb and each finger of the user remain free to move relative to the user input device when the fastener extends about the hand of the user; and
a control surface extending relative to the palm engagement portion and comprising a touchscreen input device alignable with the fingers of the user when the hand of the user is engaged with the fastener;
wherein the user is operative to contact the touchscreen input device with corresponding distal tip portions of each finger of the user to provide an input to the computing device.

2. The input device of claim 1, further comprising:
a wireless communications device for wireless communication of the input to the computing device.

3. The input device of claim 1, wherein the palm engagement portion extends relative to the palm of the user proximally to the metacarpophalangeal joint of each of the fingers of the user.

4. The input device of claim 3, wherein the fastener comprises:
a first strap extending about the hand of the user from between the metacarpophalangeal joint of the index finger of the user and the metacarpophalangeal joint of the thumb of the user and a lateral edge of the hand opposite the thumb proximal to the metacarpophalangeal joint of the adjacent finger; and
a second strap extending about the hand of the user from proximal to the metacarpophalangeal joint of the thumb to the lateral edge of the hand opposite the thumb proximal to the metacarpophalangeal joint of the adjacent finger.

5. The input device of claim 1, wherein the touchscreen device of the control surface comprises resizable input portions for selection by the user.

6. The input device of claim 5, wherein the resizable input portions are calibrated to a user's finger based at least in part on the size of the user's fingers.

7. The input device of claim 5, wherein a layout of the input portions is configurable by a user.

8. The input device of claim 1, wherein at least one of the hand-specific units comprise an input device disposed adjacent to the user's thumb for manipulation of the input device by the user's thumb.

9. The input device of claim 1, wherein the touchscreen device is operative to receive a multi-finger gesture to control a layout of input portions provided on the touchscreen device.

10. The input device of claim 1, wherein the control surface is adjustably positionable relative to the palm engagement portion.

11. The input device of claim 10, wherein the control surface is hingedly engageable with the palm engagement portion to facilitate pivotal movement of the control surface relative to an axis generally extending parallel to an axis defined by the metacarpophalangeal joints of the fingers of a user.

12. The input device of claim 1, wherein the respective hand-specific units are engageable for attachment while engaged with the hands of a user.

13. The input device of claim 1, wherein at least one of the hand-specific units is adapted to supportively engage a user device.

14. The input device of claim 13, wherein each of the hand-specific units is adapted to collectively supportively engage the user device.

15. The input device of claim 1, wherein each of the hand-specific units comprises a haptic feedback actuator for providing tactile feedback in response to a user contacting an input portion of the touchscreen device.

16. The input device of claim 1, wherein each of the hand-specific units comprises a motion sensor for determination of movement of the respective hand-specific unit.

17. The input device of claim 1, further comprising:
one or more engagement features adapted to engage an external module for interaction with the input device.

18. The input device of claim 17, wherein the one or more engagement features comprise physical features that allow for supportive engagement of the external module by the input device and a communication port that facilitate operative communication between the input device and the external module.

19. A method for use of an input device, comprising:
engaging a hand-specific unit with a first hand of a user, wherein the engaging comprises contacting an ergonomically contoured surface of a palm engagement portion with the palm of the user;
retaining the first hand-specific unit relative to the first hand of the user by a fastener engaged with the hand-specific unit that is disposed about the respective hands of the user, wherein the first hand-specific unit and the second hand-specific unit are retained on the respective first and second hands of the user without interaction by the fingers or thumb of the user;
disposing a control surface extending relative to the palm engagement portion relative to the fingers of the user to position a touchscreen input device relative to the fingers of the user to allow the user to contact the touchscreen input device with distal tips of the fingers of the user when the hand-specific unit is engaged with the hand of the user.

20. The method of claim 19, further comprising:
allow free movement of the fingers and the thumb of the user when the hand-specific unit is engaged with the first hand of the user.
